(19) United States
(12) Patent Application Publication
(10) Pub. No.: US 2011/0025157 A1
(43) Pub. Date: Feb. 3, 2011

(54) SYSTEM OF ELECTRICAL GENERATION FOR COUNTER-ROTATING OPEN-ROTOR BLADE DEVICE

(75) Inventors: Mark J. Blackwelder, Plainfield, IN (US); John Timothy Alt, Zionsville, IN (US); Steven Gagne, Avon, IN (US); Daniel Kent Vetters, Indianapolis, IN (US)

Correspondence Address: MCCORMICK, PAULDING & HUBER LLP, CITY PLACE II, 185 ASYLUM STREET, HARTFORD, CT, 06103, US

(73) Assignee: Rolls-Royce Corporation, Indianapolis, IN (US)

(21) Appl. No.: 12/510,334

(22) Filed: Jul. 28, 2009

(51) Int. Cl. H02K 23/60

(52) U.S. Cl. 310/115

(57) ABSTRACT

A counter-rotating open-rotor blade aircraft propulsion system includes a structure supporting a plurality of blades. A rotor is drivingly coupled to the structure supporting the plurality of blades. The rotor includes a rotating coil disposed in the structure supporting the plurality of blades. A rotating magnetic field source includes two Halbach permanent magnet arrays.

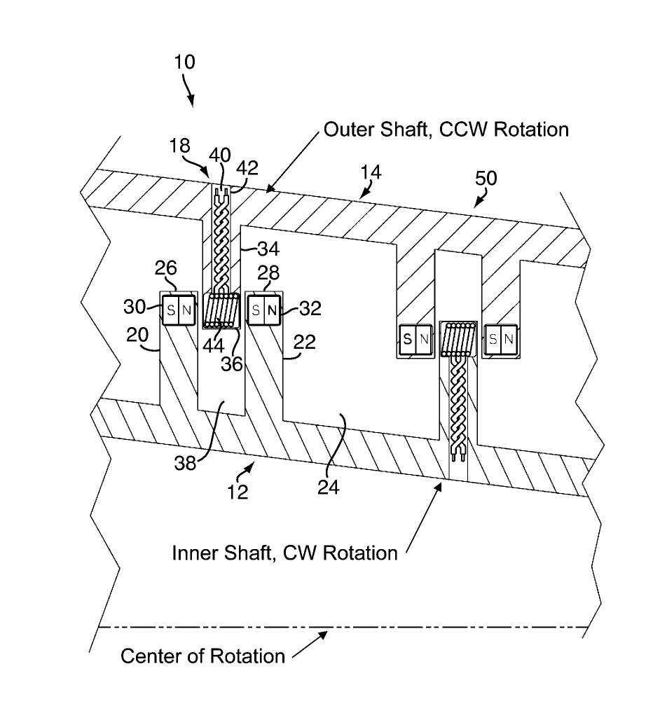

### FIELD OF THE INVENTION

The present invention relates generally to a system for transferring electrical power to the rotors of a contra-rotating open rotor aircraft propulsion system, and more particularly to the transfer of such power using Halbach permanent magnet arrays.

### BACKGROUND OF THE INVENTION

The technological background of the invention is the mechanical transfer of power to counter-rotating aircraft rotors that is then transformed into electrical power for deicing the blades on the rotors. It may be found on any rotational apparatus that requires electrical power. Some examples are helicopter rotors, airplane rotors, land vehicle wheels, or water craft vessel propellers.

Some prior art deicing technology includes Deicing Apparatus and Method: U.S. Pat. No. 4,060,212, and Microwave Deicing for Aircraft Engine Propulsor Blades: U.S. Pat. No. 5,061,836. Both of the above patents use microwave power impinging upon adsorbing structures on propulsor blades to separate ice from the blade.

Another prior art patent in the field of deicing technology is Aircraft Engine Propulsor Blade Deicing: U.S. Pat. No. 5,131,812. The above patent uses electrical heating structures on the propulsor blades to separate the ice from the blade, but does not address transfer of the electrical power to the structures.

Deicing Apparatus and Method: U.S. Pat. No. 4,060,212 and Microwave Deicing for Aircraft Engine Propulsor Blades: U.S. Pat. No. 5,061,836 both use microwaves and microwave adsorbing structures to deice rotating blades. However, this can be inefficient in the manner described because only a small fraction of the microwave power impinges on the adsorbing structures. Aircraft Engine Propulsor Blade Deicing: U.S. Pat. No. 5,131,812 is an electrical heating structure for the blades, but does not address the platform connection to or the power transfer to the structure.

With the foregoing problems and concerns in mind, it is the general object of the present invention to provide a system of electrical generation in counter-rotating aircraft rotors which overcomes the above-mentioned drawbacks.

### SUMMARY OF THE INVENTION

In an aspect of the present invention, a counter-rotating open-rotor blade aircraft propulsion system includes a structure supporting a plurality of blades. A rotor is drivingly coupled to the structure supporting the plurality of blades. The rotor includes a rotating coil disposed in the structure supporting the plurality of blades. A rotating magnetic field source includes two Halbach permanent magnet arrays.

### BRIEF DESCRIPTION OF THE DRAWING

The FIG. is a cross-sectional view of a system of electrical generation for a counter-rotating open-rotor blade device in accordance with the present invention.

### DETAILED DESCRIPTION OF THE PREFERRED EMBODIMENT

I have gained knowledge on deicing techniques and technologies from colleagues and aerospace literature. I have designed magnetic structures for several companies and hold a Doctorate of Philosophy in Electrical Engineering.

The open rotor blade deice generator embodying the present invention provides efficient power transfer to the rotating frame thus eliminating the need to use electromagnetic radiation and the side effects of inefficiency and electromagnetic atmospheric pollution or interference.

With reference to the FIG., a system of electrical generation for a counter-rotating open-rotor blade device embodying the present invention is indicated generally by the reference number 10.

The system 10 comprises a blade having an inner shaft 12 and an outer shaft 14. The inner shaft 12 is configured to rotate in an opposite direction relative to the outer shaft 14. For example, the inner shaft 12 can be configured to rotate in a clockwise direction and the outer shaft 14 can be configured to rotate in a counterclockwise direction. A center of rotation of the shafts 12, 14 is indicated by the reference number 16.

As shown in the FIG., the inner shaft 12 defines two Halbach permanent magnet arrays spaced longitudinally along the inner and the outer shafts 12, 14. The Halbach permanent magnet arrays are axial gap in configuration, but can also be implemented in a radial gap configuration.

A first Halbach permanent magnet array 18 includes two extensions or first and second arms 20, 22 longitudinally spaced from one another along the shafts 12, 14 and extending radially outwardly from the inner shaft 12 into a space 24 defined between the inner shaft 12 and the outer shaft 14. Outward ends 26, 28 of the first and second arms 20, 22 respectively accommodate first and second permanent magnets 30, 32. A central extension or third arm 34 extends radially inwardly from the outer shaft 14 such that an inward end 36 of the third arm 34 is longitudinally interposed in a space 38 defined between the first and the second outward ends 26, 28 of the first and second arms 20, 22.

The first and the second permanent magnets 30, 32 each have north and south poles longitudinally spaced along the shafts 12, 14 relative to each other. For example, the first arm 20 accommodates the first permanent magnet 30 at the outward end 26 such that a north pole faces the third arm 34. The second arm 22 accommodates the second permanent magnet 32 at the outward end 28 such that a south pole faces the third arm 34.

The third arm 34 defines a channel 40 extending from a base 42 at the outer shaft 14 to the inward end 36. An electrical coil 44 is accommodated in the channel 40 at the inward end 36 such that a central longitudinal axis of the electrical coil extends generally in a longitudinal direction of the shafts 12, 14.

A second Halbach permanent magnet array 50 is spaced longitudinally along the inner and the outer shafts 12, 14 relative to the first Halbach permanent array 18. The components of the second Halbach permanent array 50 are the same as that of the first Halbach permanent array 18. Therefore the description of the components of the second Halbach permanent array 50 need not repeated.

Features of the open rotor blade deice generator are a rotating magnetic field source and a rotating coil structure that is in the same rotating structure as the blades requiring deice power. The rotating magnetic field source is composed of two Halbach permanent magnet arrays. These arrays may be composed of any permanent magnet material such as Neodymium Iron Boron or Samarium Cobalt. The magnet field source is composed of many permanent magnet sections that are manufactured to have field directions that are dependent on the relative angular position. The field direction is the sinusoid of the angle of the center of the permanent magnet section.

Coils comprising conductors are situated between these two Halbach permanent magnet arrays. The magnetic flux passing through the coil of conductors from the Halbach permanent magnet arrays generates the electricity to deice the blades on the same rotor.

The present invention provides a new capability of transferring power mechanically from the stationary airframe to the rotating frames of the counter rotating open rotor design and then transforming the power into electricity via electromagnetic conversion. Specifically, it is the first application of Halbach magnet arrays used in axial flux path, embedded, electromagnetic machines to transform power in the air gap between the airframe and the rotors of an open rotor aircraft propulsion system.

There are several difficulties with transferring power to the rotors of a contra-rotating open rotor aircraft propulsion system. Mechanical transfer requires rotating contact that wears, leaks, is inefficient or is heavy. Optical transfer is inefficient with practical technologies and is susceptible to interference from opaque materials. Chemical transfer requires mass transfer across rotating mechanical structures that are also susceptible to wear and leaks. Radiation is inherently dangerous and increases thermal management of the propulsion system. The conventional method uses slip rings that have proven failure modes associated with hydraulic fluid mixing with carbon dust and causing arcing. Slip rings are also high maintenance items requiring servicing on the order of hundreds of hours of operation.

Since weight is a key performance parameter, Halbach based machines reduce the need for magnetic flux guidance with iron or steel. This typically increases the volume of permanent magnet necessary, but the reduction in steel more than compensates. The notion is an axial flux machine with a double sided stator and two Halbach permanent magnet rotors, i.e. “pancake” generator. This arrangement is self-shielding, which alleviates eddy currents in the surrounding structures. The Halbach arrangement reduces or eliminates torque ripple and electrical harmonics. The magnetic coupling in an axial flux path of the dual magnet groups to the coils eliminates wear and is efficient.

The embodiments of the apparatus may be in any form where magnetic field is modulated within a conducting coil. Field wound rotor, permanent magnet brushless DC motors are all examples of electromechanical conversion techniques that are applicable for this apparatus. Below is an exemplary embodiment using Halbach permanent magnet arrays and no iron or steel for flux guidance.

### Specifications:

Three phase voltage: 208 VRMS
Machine mechanical speed: 20 Hz (1200 RPM)
Three phase frequency: 360 Hz

### Power Factor: 0.9

Magnet Coercive Force: 980 kA/m
Copper Density: 9 g/cm³
Permanent Magnet Density: 7.4 g/cm³
Radial length: 0.47 m
Minimum speed for full power: 1200 RPM
Leakage flux: 0 T
Armature resistance: 0 ohms
Current density: 5 amps per square millimeter
Infinitely thin conductors (for magnetic portion only)
Eighteen poles provide the desired frequency. The magnetic field is considered sinusoidal with respect to angle across the face of the magnet pole piece. Thus the flux coupled into a single stator coil is

φ=∫μ₀·H(θ)·l·r·dθ

For a coil that covers two thirds of the pole face, taking the minimum field intensity at zero radians mechanical, and assuming phase A is aligned with zero radians mechanical, the back electromotive force for phase A is

$${E}_{a} = \frac{1}{\sqrt{2}} \cdot {ω}_{m} \cdot {N}_{coil} \cdot {N}_{s} \cdot r \cdot l \cdot {μ}_{0} \cdot \frac{( l\_m + 2 \cdot w\_mag )}{l\_ap} \cdot {H}_{c} \cdot \frac{2}{P} \cdot sin ( \frac{π}{3} ) \cdot cos ( {θ}_{r} )$$

in volts RMS.

Where ωₘ is the mechanical rotational velocity in radians per second, N_{coil} is the number of coils per phase, Nₛ is the number of turns per coil, r is the average radius in meters, l is the height of the magnet section in meters, μ₀ is the permeability of free space and the permanent magnet in henries per meter, l_m is the thickness of the magnet in meters, w_mag is the width of the magnet section in meters, l_ap is the average length of the flux air path including the permanent magnet path in meters, H_{c} is the coercive force of the permanent magnet in amps per meter, and θᵣ is the angle between the rotor quadrature axis and phase A of the stator. The back EMF is at a maximum when θᵣ is zero radians.

The inductance per phase is

$${L}_{m} = {N}_{coil} \cdot \frac{{N}_{s}^{2} \cdot {μ}_{0} \cdot l \cdot l\_m}{l\_ap}$$

in henries. For a load resistance per phase of 1.5429 ohms, 18 pole pairs, 19 turns per stator coil, and a 75 millimeter tall, 9 millimeter thick, 82 millimeter wide permanent magnet section the power factor is 0.998, the volume of active material is 8.71 liters, and the mass of the active material is 78 kilograms for two 28 kilowatt generators.

As will be recognized by those of ordinary skill in the pertinent art, numerous modifications and substitutions can be made to the above-described embodiments of the present invention without departing from the scope of the invention. The present invention can be embodied, for example, in any type of generator such as permanent magnet array that is located between the counter rotating prop shafts for the purpose of providing deicing power to the propeller blades. Accordingly, the preceding portion of this specification is to be taken in an illustrative, as opposed to a limiting sense.

What is claimed is:

1. A counter-rotating open-rotor blade aircraft propulsion system comprising:
a structure supporting a plurality of blades;
a rotor drivingly coupled to the structure supporting the plurality of blades, the rotor including:
a rotating coil disposed in the structure supporting the plurality of blades; and
a rotating magnetic field source including two Halbach permanent magnet arrays.

2. A system as defined in claim 1, wherein the rotating coils are disposed between the two Halbach permanent arrays.

3. A system as defined in claim 1, wherein the two Halbach permanent magnet arrays include one of neodymium iron boron and samarium cobalt.
